(19) United States
(12) Patent Application Publication
(10) Pub. No.: US 2008/0317028 A1
(43) Pub. Date: Dec. 25, 2008

(54) MULTICASTING IN A COMMUNICATION NETWORK

(76) Inventors: Gregory Chockler, Haifa (IL); Roie Melamed, Haifa (IL); Yoav Tock, Nesher (IL); Roman Vitenberg, Oslo (NO)

Correspondence Address: IBM CORPORATION, T.J. WATSON RESEARCH CENTER, P.O. BOX 218, YORKTOWN HEIGHTS, NY, 10598, US

(21) Appl. No.: 11/764,809

(22) Filed: Jun. 19, 2007

(51) Int. Cl. H04L 12/56; H04J 3/26

(52) U.S. Cl. 370/390; 370/432

(57) ABSTRACT

Systems and methods for managing connections among nodes in a communication network are provided. The method comprises determining one or more topics of interest for a first node in the network, selecting a second node in the network that shares at least a first topic of interest with the first node, establishing a connection between the first node and the second node so that the second node covers at least the first topic of interest, and establishing additional connections between the first node and at least a third node in the network that covers at least the first topic of interest, in response to determining that the first node is not covered by a total of K nodes with respect to the first topic of interest. Preferably, the communication network is a publish/subscribe network.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to communication networks and, more particularly, to a method and system for managing multicasting in a communication network.

### BACKGROUND

A computer network may be deployed to broadcast (i.e., multicast) data among a plurality of nodes (e.g., computer systems) in the network. Certain nodes may publish the information that is multicasted, while others may subscribe to certain topics of interest to receive the published information.

In a topic-based publish/subscribe (pub/sub) system, messages or events are published on abstract event channels associated with various topics of interest. Users interested in receiving messages published on certain topics issue subscribe requests specifying their topics of interest. The pub/sub infrastructure then distributes each newly published event to all the users that have expressed interest in the event's topic. Due to its simple interface and decoupling of publishers and subscribers, pub/sub-based middleware is commonly used to support many-to-many communication in a wide variety of applications, such as enterprise application-integration, stock-market monitoring engines, RSS feeds, on-line gaming, etc.

Typically, a large data center has thousands of nodes in which hundreds of distributed applications are deployed. Each node hosts dozens of applications and each application is deployed over dozens to hundreds of nodes. Each application is allocated a topic for intra-application communication purposes, most nodes being both publishers and subscribers. Furthermore, the deployment of applications on nodes may be dynamic and dependent upon the relative load incurred upon the nodes.

A communication network comprised of multiple nodes can be described by an overlay topology, which depicts the flow of data between the nodes. An application level overlay network topology consists of a collection of nodes built on top of an existing network. For example, many peer-to-peer networks are overlay networks because they run on top of the Internet. Examples of network overlay topologies include centralized networks and distributed networks.

Referring to FIG. 1A, a centralized communication network is provided wherein a central node S is connected to nodes N1 through N6 with a point-to-point connection in a ‘hub’ and ‘spoke’ fashion where a collection of point-to-point connections from the peripheral nodes converge at the central node. In this topology, data communicated between the nodes is transmitted through the central node S. This limits communication efficiency and reliability of the system as the available bandwidth and processing power of central node S dictates the throughput of the network. In this topology, all processing overhead is allocated to the central node.

To overcome the above problem, a distributed topology may be used to decentralize the processing and communication functions in a network. In a distributed topology, a meshed network may be employed. In a fully meshed network each node is connected to each other node thus distribution of information from one node to any node in the network can be done directly from any node, without having to go through a centralized node or any other node. Unfortunately, however, a fully meshed topology is inefficient in a network that includes a large number of nodes, because maintaining the overhead associated with all connections between all nodes is very expensive.

Referring to FIG. 1B, in the depicted overlay, topic A is connected, since the subgraph induced by the nodes interested in topic A (nodes N1, N2, and N5) is a connected component. Referring to FIG. 1C, in the depicted overlay, nodes N1, N3 and N5 each have an interest in topic B, wherein topic B is disconnected, since the subgraph induced by the nodes N1, N2, and N5 is not a connected component.

As shown in FIGS. 1B and 1C, instead of a fully meshed network, a partially meshed network may be employed. In a partially meshed network, a node maintains connections with a small number of other nodes, instead of maintaining connections with all the other nodes as in a fully meshed overlay. In this manner a smaller number of connections will need to be supported by the system overlay. Thus, as depicted in FIG. 1C, if a publication is to be transmitted from a first node (e.g., N1) to a second node (e.g., N3) that is not directly connected to the first node, the transmission will typically have to be routed through one or more intermediary nodes (e.g., node N4 or nodes N2 and N6).

Accordingly, in a partially meshed network, a certain amount of delay is associated with the transmission of data between indirectly connected nodes, as a trade-off to not having to maintain the overhead associated with maintaining connections between all nodes. To limit the delay in transmission, the connections between the nodes may be based on the similarity of subscriptions. That is, creation of links in the overlay can be based on similarity in the nodes' subscription interest in one or more topics.

Overlay-per-topic topologies, (i.e., constructing a dedicated overlay per topic), scale well with the number of nodes. However, they are not scalable with the number of subscriptions per-node. Even a simple logical topology, such as a tree or a ring, requires each node to maintain an average of two connections per subscription. Thus, the number of connections required grows linearly as the number of interested topics for each node increases. For large-scale settings, such as the large data center described above, or a stock-market broker interested in many dozens or even hundreds of quotes, this approach becomes impractical due to node degree limits.

Further, the current practice of the overlay-per-topic approach does not take full advantage of the fact that under typical workloads there is substantial correlation between the interests of different nodes in minimizing/optimizing average node degree. The overlay-per-topic approach only exploits this correlation in a post-processing edge-collapsing stage, rather than building a single overlay that takes into account the correlation between the interests of different nodes in the process of choosing neighbors.

As such, the above-discussed topologies do not scale well to a large data center deployment scenario because they cannot provide the desirable overlay topological characteristics of topic connectivity, scalable average node degree, scalable topic diameter, and churn resistance. Topic connectivity exists when all of the nodes in a network that are interested in a topic t create a connected component, where each interested t-topic node is connected in the same subgraph overlay.

Average node degree is the number of reliable long-lived (e.g., TCP) connections a node maintains as part of the overlay. Topic diameter is the maximum hop-count between a pair of nodes interested in the given topic. And, churn resistance is the ability of the overlay to remain topic-connected and maintain low average node degree, despite nodes leaving, joining and changing their topic of interest.

In order to achieve selective event dissemination, most existing pub/sub systems leverage the properties provided by structured overlay networks, and organizing peers into global dissemination overlay topologies, such as multicast trees. A smaller number of pub/sub architectures are based on unstructured overlays that employ a combination of an unstructured overlay and additional ring structures to support content-based pub/sub. Other architectures assume that topics are organized into a hierarchy in the naming space and construct a hierarchy of unstructured overlays that is based on the topic hierarchy.

Although relying on structured elements is instrumental for routing efficiency, maintaining global topologies incurs the cost of reconfiguration in the presences of dynamic changes, thus making these systems less favorable in highly dynamic settings. Other techniques of building an overlay that are typically used to support decentralized topic-based pub/sub communication include a ring-per-topic overlay, an overlay constructed based on a similarity heuristic, and a fully random overlay. However, in a large setting, these typical overlays result in a less than desirable high average node degree.

Thus, methods and systems are needed that can overcome the aforementioned shortcomings by more efficiently managing connections between nodes in a network according to the topics of interests associated with each node.

### SUMMARY

The present disclosure is directed to systems, methods and corresponding products that facilitate multicasting in a communication network.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for managing multicasting in a communication network is provided. The method comprises determining one or more topics of interest for a first node in a network; selecting a second node in the network that shares at least a first topic of interest with the first node; establishing a connection between the first node and the second node so that the second node covers at least the first topic of interest; and establishing additional connections between the first node and at least a third node in the network that covers at least the first topic of interest, in response to determining that the first node is not covered by a total of K nodes with respect to the first topic of interest.

In accordance with one aspect of the invention, a multicasting system is provided. The system comprises one or more logic units for performing the functions and procedures discussed above. In another embodiment, a computer program product comprising a computer useable medium having a computer readable program is provided. The computer readable program when executed on a computer causes the computer to perform the functions and procedures discussed above to provide a multicasting service.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1A is a diagram of a centralized network overlay topology.

FIGS. 1B and 1C are diagrams of networks with partially meshed overlay topologies.

FIGS. 2A through 2D are exemplary diagrams of a network overlay topology, according to one or more embodiments.

FIG. 3 is a flow diagram of a method for connecting a node to one or more nodes in a network, in accordance with one embodiment.

FIG. 4 is a flow diagram of a method for disconnecting a node from one or more nodes in a network, in accordance with one embodiment.

FIGS. 5 and 6 are block diagrams of hardware and software environments in which a system of the present invention may operate, in accordance with one or more embodiments.

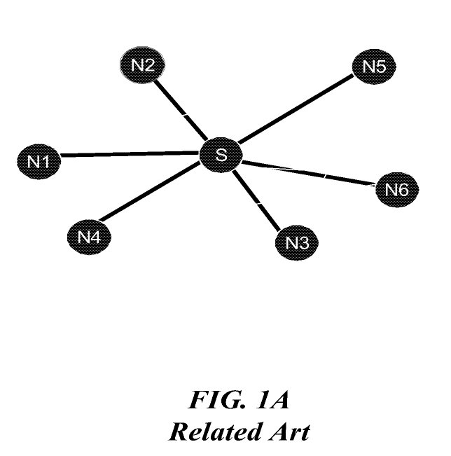

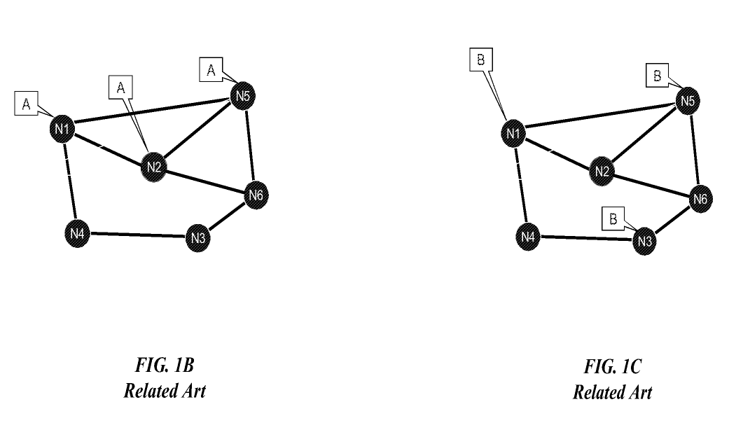

Features, elements, and aspects of the invention that are referenced by the same numerals in different figures represent the same, equivalent, or similar features, elements, or aspects, in accordance with one or more embodiments.

### DETAILED DESCRIPTION OF EXEMPLARY EMBODIMENTS

The present disclosure is directed to systems and corresponding methods that facilitate multicasting in a communication network.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

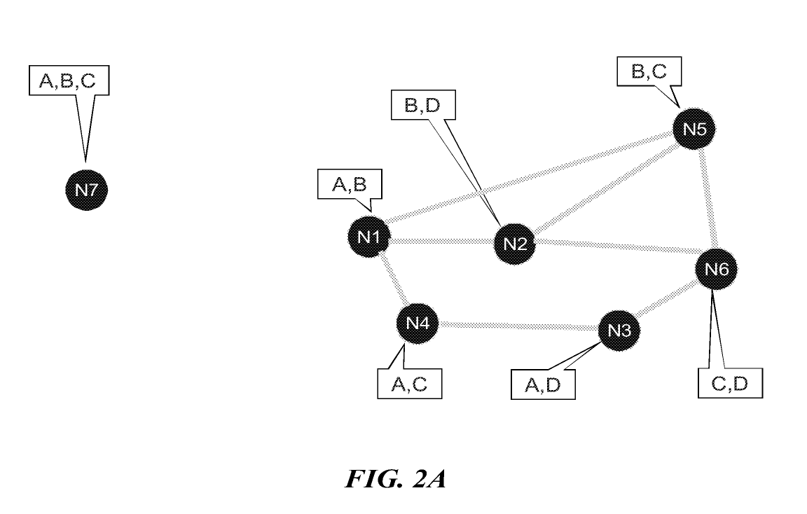

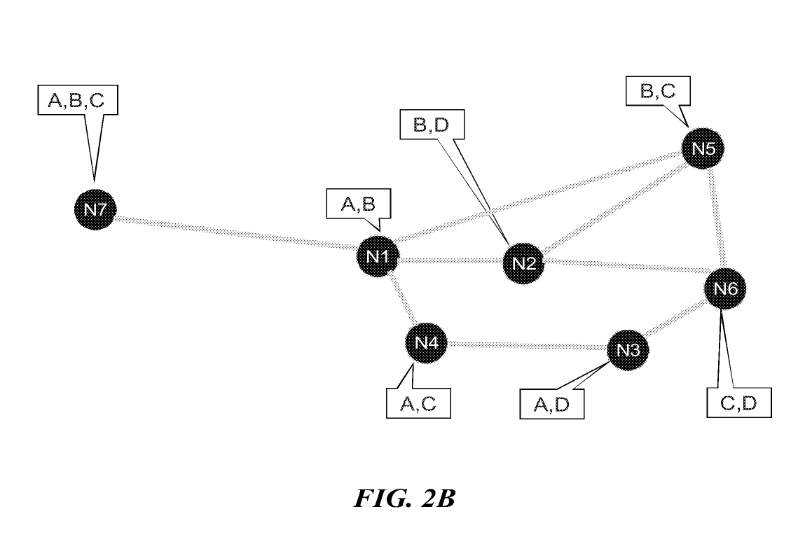

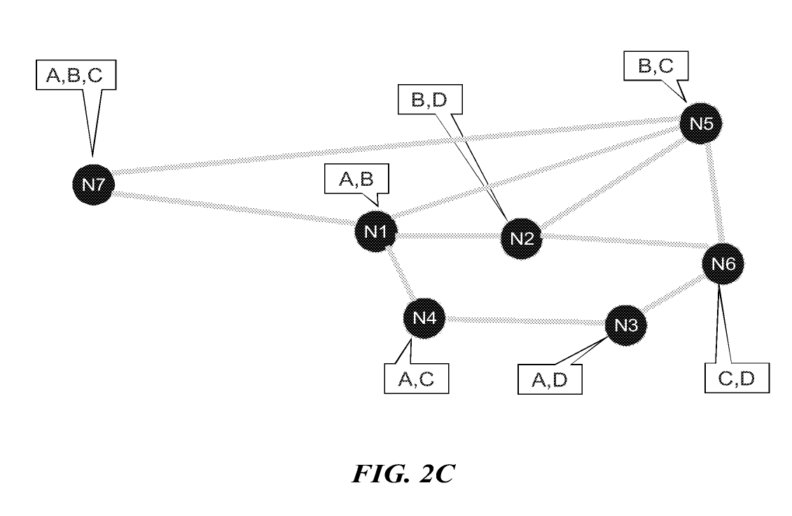

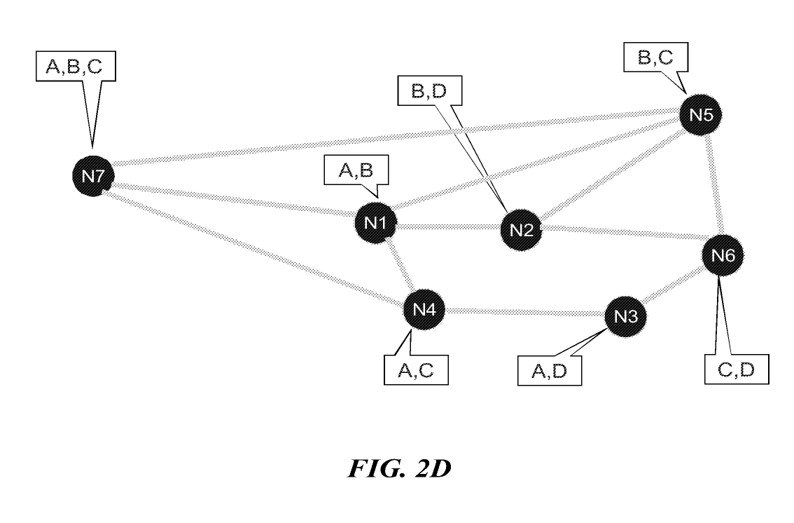

Referring to FIG. 2A, a plurality of nodes in a network are depicted wherein a node N7 may subscribe to multiple topics of interest (e.g., A, B and C) in accordance with an exemplary embodiment. Node N7's subscription may be serviced by the exemplary network comprising nodes N1 through N6. To provide such service, a method is needed to connect N7 to: either one or more nodes in the network that publish content associated with N7's topics of interest, or to nodes that themselves subscribe to the same topics of interest.

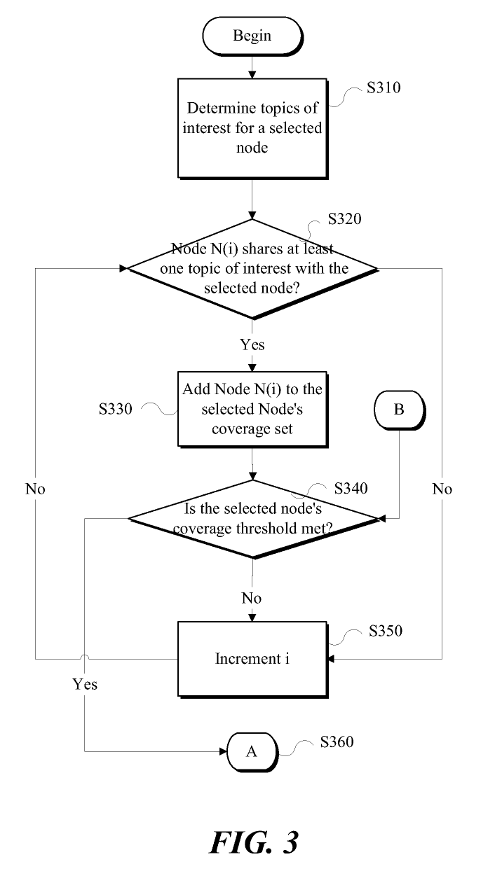

Referring to FIGS. 2A through 2D and FIG. 3, in one embodiment, the system first determines the topics of interest for a selected node (e.g., node N7) (S310). As shown, the topics of interest for N7 are A, B and C. However, neither of the nodes N1 through N6 in the network individually covers all three topics of interest for N7. For each node N₍ᵢ₎ in the network, it is determined if node N₍ᵢ₎ shares at least one topic of interest with the selected node N7 (S320). If so, the node N₍ᵢ₎ is added to N7's coverage set (S330) and the process continues for the next node (e.g., node N₍ᵢ₊₁₎) in the network, until N7's coverage threshold for each topic of interest is met (S340, S350).

In accordance with one embodiment, the coverage set for a node includes the set of nodes in the network that are connected to that node and share at least one topic of interest. As such, in the following, when we refer to, for example, a first node being included in the coverage set for a second node, it is meant that the first and second nodes are connected with respect to a topic of interest. Similarly, when we say that a first node covers a second node with respect to a topic of interest, it means that both the first and the second node have a common interest in the same topic.

A coverage threshold K can be set for each topic of interest according to system requirements and depending on implementation. The coverage threshold K represents a value that indicates the number of times a topic of interest for a selected node is covered by the nodes to which the selected node is connected. For example, in FIGS. 2B to 2D, the coverage threshold for all topics of interest A, B and C is 2. When N7 is connected to node N1 with topics of interest A and B, said topics of interest are covered once, but topic C remains uncovered. Therefore, according to the method provided in FIG. 3, N7 continues to connect to the next node N5 covering interests B and C (see FIG. 2C). At this point, the coverage threshold for topic B is met (i.e., K_{B}=2), but coverage threshold for topics A and C is not met (i.e., K_{A}=1, K_{C}=1).

Referring to FIG. 2D, node N7 is connected to node N4 covering topics of interest A and C. After connecting to node N4, node N7 is K-covered with respect to all its topics of interest (i.e., K_{A}=2, K_{B}=2, K_{C}=2). It is noteworthy, that in FIG. 2D, node N7 is K-covered, thus so long as the connection between all the nodes is maintained, the threshold K=2 for all topics of interest for node N7 in the network of FIG. 2D is met.

It should be emphasized that the above exemplary network, the topics of interest, number of nodes, and the threshold K value selected in the illustrated embodiment are all by way of example. Therefore, the scope of the invention should not be construed as limited to these exemplary values or relationships. Rather, the number of nodes and their relationship, in addition to the threshold value for each topic of interest can vary depending on system requirements and implementation.

As provided in further detail below, depending on implementation, a selected node's topics of interest may be covered by way of first connecting the node to those nodes in the network that share at least a certain number of topics of interest with the selected node (e.g., N7). For example, the selected node first may try to satisfy the threshold coverage by connecting to those nodes in the network that share at least X topics of interest with the selected node.

In some embodiments, the selected node may first try to connect to those nodes in the network that share with it all the same topics of interest. In the alternative, in one embodiment, the selected node may attempt to connect to those nodes in the network that share with it the most number of common topics. Depending on implementation the above methods by way of example may be referred to as the “greedy” method hereafter, represented by Kg (i.e., K greedy).

If the coverage threshold for a selected node is not covered based on the above methods, then depending on implementation the selected node may continue to connect to other nodes that have a smaller number of common topics of interest with the selected node. For example, Kr may represent connecting to a node that has at least one common topic of interest with the selected node. Hereafter, we refer to methods for connecting to a node that has at least one common interest with the selected node as the less greedy method or as the random method by way of example.

In one exemplary embodiment, to obtain K-coverage, Kg may be set to 4 (i.e., each topic to which the selected node is subscribed is covered 4 times), and Kr may be set to 1 (i.e., connecting to nodes that share at least one topic of interest with the selected node). Thus, Kr may be used to achieve K-coverage, if K-coverage is not achieved by the greedy method alone.

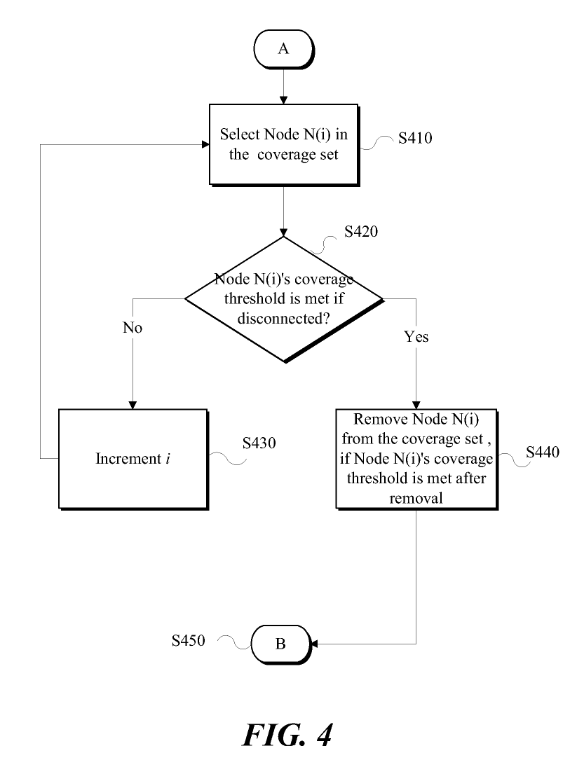

Now referring to FIG. 4, it is possible that after the nodes in a network are K-covered based on the above-noted methods, for certain nodes to be over covered (i.e., excessively covered beyond a threshold) with respect to one or more topics of interest. For example, an upper threshold limit for a node's K-coverage with respect to a topic of interest may be represented by a value L^{max}.

In one embodiment, to ensure that a target node in the network is not covered beyond the upper threshold, a node N₍ᵢ₎ in the coverage set for the target node is selected such that node N₍ᵢ₎ at least covers the topic of interest which is overly covered (S410). It is then determined if node N₍ᵢ₎'s coverage threshold with respect to at least one of its topics of interest is maintained if node N₍ᵢ₎ is disconnected from the target node (S420). If so, the counter i is incremented (S430); that is, another node N₍ᵢ₊₁₎ connected to the target node is examined for the purpose of disconnection from the target node.

Otherwise, if it is determined that disconnecting node N₍ᵢ₎ from the target node does not adversely affect node Nₓ's coverage for its topics of interest, then node N₍ᵢ₎ is removed from the target node's coverage set (S440) so that the target node is no longer overly covered with respect to a certain topic of interest. If the target nodes after disconnection from node N₍ᵢ₎ remain overly covered with respect to the same topic of interest or another topic of interest the above-noted process continues by removing other nodes from the target node's coverage set, until the needed equilibrium is achieved.

It is noteworthy that to the same extent that a greedy algorithm can be employed for achieving K-coverage when a topic of interest is under-covered, a similar greedy algorithm may be also applied to return to K-coverage when a topic of interest is overly covered.

Certain exemplary embodiments of the invention are disclosed with reference to sample pseudo codes and algorithms that are discussed in detail in the following. It remains important to reemphasize and understand that the following is merely provided for the purpose of example so that the reader can fully appreciate certain exemplary implementations. In no event should the following examples be construed as limiting the scope of the invention.

In an exemplary embodiment, a method for achieving K-coverage can be implemented based on two components: a membership protocol, and an overlay construction and maintenance protocol. Both protocols may be fully distributed. The construction protocol aims to achieve connectivity and low diameter for the entire set of topics, while maintaining as few overlay links as possible.

The interest of a node may be the list of topics to which the node has either subscribed to, or is going to publish on. A selection algorithm may be used to achieve K-coverage for a node by combining the greedy and random methods noted earlier. In both methods, each node may try to cover K times each of the topics in which it is interested. That is, for each topic t in which the node is interested, the node tries to maintain connections to K other nodes that are also interested in topic t.

In some embodiments, the greedy and random methods differ in the way they connect to a neighboring node (i.e., a node that is a candidate for being a neighbor) in that said methods use different coverage parameters, Kg and Kr, respectively. The greedy method preferably selects a neighboring node that minimizes the number of topics which are not yet Kg covered. In contrast, the random coverage randomly selects a node whose addition as a neighbor would reduce the number of topics that are not yet Kr covered.

According to theory of k-regular random graphs, for Kr≧3, if each node achieves Kr coverage, then for each topic t, all the nodes interested in topic t form a connected component, with high probability, whose diameter grows logarithmically with the number of subscribers to this topic. Such coverage heuristic achieves the desired connectivity and low diameter per each topic.

To exploit correlated workloads, which are common in practice (e.g., in pub/sub applications such as RSS and stockmarket monitoring engines), the greedy coverage heuristic may be used. In many practical workloads, each link created by the greedy heuristic covers, on average, much more than a single topic, whereas each link created by the random coverage heuristic covers about a single topic. In principle, however, greedy coverage alone may not ensure, with high probability, the desired topic connectivity. Thus, the values chosen for Kg and Kr provide a tradeoff between the average node degree, and interest-based connectivity.

In one embodiment a membership scheme is used to allow each node in both the greedy and the random coverage heuristics to maintain an interest view of other nodes in the system. The interest view includes the identities of other nodes along with their interests, and may be partial and randomized. An interest view may be readily implemented by distributed probabilistic membership protocols augmented with the interest information. For example, each node may know the identities and interests of at least five percent of the nodes in order to achieve both low average node degree and topic-based connectivity.

In building and maintaining an overlay of connected nodes, the greedy and random neighbor maintenance processes may execute the same routine with the exception of the neighbor selection routine. In addition, each of these two tasks may independently manipulate its own set of the data structure consisting of the same collection of variables, where possible.

The following exemplary embodiment describes the implementation of one of the neighbor maintenance tasks without an explicit reference to the exact type of neighbors being maintained. K refers to the coverage parameter. Exemplary data structures maintained by each node p are shown in Code Section 1 below. The neighbors set for each current neighbor q of p may include an identifier (id) for node q, in addition to that node's degree, target degree, and current interest, for example. Further, each node may hold its own interest in a variable herein after represented as “self_interest” by way of example.

In one embodiment, a failure detection mechanism is used to determine if a neighbor node is alive and capable of communicating with the other nodes in the network. The failure detection mechanism may be based on querying or expecting to receive a signal (i.e., heartbeat) from a neighboring node at particular intervals. If the signal is not received or no response is provided, then it is determined that the node is no longer connected to the network. The failure detection mechanism may also be used to periodically update a node's neighbors with some elements of the node's internal state, such as its degree, and target degree.

The neighbor maintenance task may start from an empty neighbors set, and incrementally add neighbors. Neighbors are added, according to a greedy or random heuristic discussed above, until the node reaches K-coverage, such that each topic in the node's interest is represented by the interests of at least K of its neighbors. In some embodiments, however, the node may not add neighbors without a limit.

The number of neighbors in one embodiment may be limited to L^{max}+Margin, where Margin may be a small constant (e.g., 5). When the degree exceeds L^{max}, the node preferably stops adding new neighbors, and actively tries to disconnect from at least one of its neighbors. In an exemplary embodiment, L^{max} is chosen to be equal to a value represented by K*|self_interest|, such that in the worst case, a node reaches K-coverage with each neighbor covering a single topic. In most cases, however, and especially with the greedy heuristic, most nodes should reach K-coverage with less than L^{max} neighbors, because each neighbor may cover more than one topic, on average.

Nodes may be added into a set (e.g., a neighbors set) by either sending connect requests, or by accepting connect requests. It is therefore possible for a node to become over-covered. If so, some neighboring nodes may need to be removed from the neighbors set without hampering the K-coverage property of the nodes. In one embodiment, when a node becomes over-covered, it may try to disconnect from some existing neighbors whose removal would not affect the desired coverage level of the node defined by a self_interest value, for example.

In one embodiment, a node p may remove a node q from its neighbors set and stay K-covered, for example, whereas q would lose its K-coverage as a result of this disconnection, or q may have been under-covered to begin with. In some embodiments, the neighbors set is augmented with the degree and target degree of each neighbor. This allows each node to deduce the coverage state of its neighbors.

In accordance with one or more embodiments, a neighbor maintenance task may be implemented to monitor K-coverage for a node. The neighbor maintenance task may comprise two parts. A connect routine may be utilized to obtain K-coverage by connecting to at least one new neighbor, until K-coverage is achieved, or until L^{max} is exceeded. A disconnect routine may be utilized to keep the node's degree from growing too much, by trying to disconnect from at least one existing neighbor whose removal would not hamper the desired coverage level. The disconnect routine may be executed when a node's degree exceeds L^{max}, or when the node is over-covered.

Referring to code sections 1 through 4 below, depending on implementation, the neighbor maintenance task may comprise several routines. The main routine called MAINTAINNEIGHBORS, appears in Code Section 2. Its goal is to maintain K-coverage with as few neighbors as possible, but with less than L^{max}+Margin neighbors. It executes in an infinite loop, as long as K>0. In some embodiments, it is possible to disable the greedy or random maintenance routine by setting Kr or Kg=0.

In an exemplary embodiment, when MAINTAINNEIGHBORS starts a new iteration of the loop, it first invokes the CALCKUNCOVERED routine, as depicted in Code Section 3, to calculate the number of topics that are not sufficiently covered by the current node neighbors' interest. Based on the CALCKUNCOVERED's return value, either one of a connect or disconnect routines may be invoked. If at least one insufficiently covered (i.e., under-covered) topics are found, and the overall number of the node's neighbors is smaller than L^{max}, the connect routine may try to add a new neighbor (see for example Code Section 2, lines 7-10). If, on the other hand, there are no under-covered topics or, the node's degree is higher than L^{max}, the disconnect routine may try to remove a neighbor.

In accordance with one embodiment, the connect routine may try to establish a connection with a new node. The new node to connect to, may be either chosen by the NEXTCOVERAGENODE routine, or from among the nodes accumulated in the connect_cand_from_redirect set. The set connect_cand_from_redirect contains the identities of nodes that the node was redirected to, after trying to connect to at least one node that could accept it as neighbor. Referring to Code Section 5, the NEXTCOVERAGENODE routine may be substituted by either NEXTGREEDYCOVERAGENODE for the greedy neighbor maintenance, or NEXTRANDOMCOVERAGENODE for the random neighbor maintenance. When a node receives a connect request, for example, the node may accept it if the node's degree is lower than L^{max}+Margin. In such a case, the requesting node is added to the neighbors set.

In some embodiments, when a node receives a connect request, the node accepts the request if the node's degree is lower than L^{max}+Margin. In this embodiment, the requesting node is added to the neighbors set. Otherwise, the node, by issuing a redirect message, redirects the requesting node to a node m in the neighbors set where (1) m has not reached its target degree, and (2) m shares the maximum amount of interest with the requesting node, for example.

When a first node receives a redirect message, the first node may add the sending node to the connect_cand_from_redirect set (see for example Code Section 4, lines 10-11). In turn, the first node may try to connect to the sending node at the next iteration of the MAINTAINNEIGHBORS routine. In some embodiments, the process of adding links continues until the topics are K-covered for the first time, or until the node's degree reaches the upper bound L^{max}, in which case, the node will preferably not try to initiate new connections with new nodes.

In an exemplary embodiment, the disconnect routine preferably starts with the node setting its adaptive degree target L to the minimum of L^{max} and |value of the neighbors set| thus indicating that the node has reached, or exceeded, the minimum degree required to K-cover the node's set of topics (see for example Code Section 2, lines 22-26). Preferably, the related values are included in CONNECT and CONNECT-OK messages, and are periodically distributed to the node's neighbors, piggybacked on the heartbeat messages, for example. Said values are stored in the degree and target fields of the respective neighbors set entry, for example. Thus, the neighbors of a fully K-covered node q will know whether the node has reached K-coverage or not.

In one embodiment, a node may invoke DISCONNECTCANDIDATE to select a neighbor to disconnect from. In one embodiment, the neighbor is chosen from among those neighboring nodes whose degree has exceeded the minimum degree for the complete coverage of their interest, and whose removal would have the minimum impact on the K-coverage. If such a neighbor is found, it will be sent a disconnect request, preferably when one or more of the following conditions apply: (1) the node's degree is above L^{max}, or (2) the candidate can be removed without causing the node to be under-covered. Accordingly, the degree will not grow much above Lₘₐₓ, and over-covered nodes try to reduce their degree to a minimum where they remain K-covered.

In one embodiment, when a node p receives a disconnect request from another node q, the node will disconnect from q if the node can remove q without causing its interest to become under-covered, or if the node has more than L^{max} neighbors. If indeed p decides to disconnect from q, it will send a DISCONNECT-OK message which will cause q to remove p from its neighbors set.

In accordance with one or more embodiments, redirect messages may be used to prevent a case in which the node p tries to repeatedly connect to the same node q and is being rejected. In an exemplary embodiment, the nodes in connect_cand_from_redirect are given priority when choosing the next node to connect to (see for example Code Section 2, lines 15-19). In some embodiments, neighbors that have exceeded their target degree will not be chosen as redirect candidates.

Accordingly, one or more embodiments of the invention are implemented to handle dynamic changes to a network with a failure detection event handler, by removing suspected nodes from the neighbor set. The suspect node's neighbors may try to connect to new neighbors at the next round of the neighbor maintenance task. An orderly leave message may be sent to the neighbors. When a node p changes its interest, the change is propagated through the membership service and via the heart beat messages. The neighbors of the node p, and or other nodes in the network may take this change into account in the next round of the neighbor maintenance task.

Code Section 1: Data Structure and Parameters Used by the Neighbor Maintenance Implementation

### Parameters:

K: the desired interest coverage
Margin: The number of additional links the node is allowed to maintain after the desired interest coverage has been reached
L^{max}: an upper bound on L
Algorithm_version: greedy or random neighbor selection

### Data Structure:

id: this node's identifier
interest: a set of topic-id's
self_interest: the interest of this node
interest_view: a set of pairs [symbol] id,interest [symbol]
“neighbors”: sets of records <id,degree,target,interest>, initially 0
connect_cand_from_redirect: a set of node identifiers, initially 0
L: the (adaptive) target number of neighbors

Code Section 2: The Neighbor Maintenance Routines

| | |
|---|---|
| 1. | procedure MAINTAINNEIGHBORS( ): |
| 2. | gap ← 0 |
| 3. | loop as long as K > 0 |
| 4. | L^{max} ← K • \|self interest\| |
| 5. | under_covered [symbol] CALCKUNCOVERED |
| | (self_interest,neighbors) |
| 6. | if (under_covered > 0) then |
| 7. | L ← L^{max} |
| 8. | gap ← L − \|neighbors\| |
| 9. | if (gap > 0) then |
| 10. | CONNECT( ) |
| 11. | if (under_covered = 0) [symbol] (under_covered > |
| | 0 [symbol] gap < 0) then |
| 12. | DISCONNECT( ) |
| 13. | sleep(connect_timeout) |
| 14. | procedure CONNECT( ) |
| 15. | if connect_cand_from_redirect = 0 then |
| 16. | n ← NEXTCOVERAGENODE(algorithm |
| | version) |
| 17. | else |
| 18. | n ← some node from |
| | connect_cand_from_redirect |
| 19. | remove n from connect_cand_from_redirect |
| 20. | send [symbol] CONNECT, \|neighbors\| ,L,self_interest [symbol] to n |
| 21. | procedure DISCONNECT( ) |
| 22. | L ← min(L^{max}, \|neighbors\| ) |
| 23. | over ← \|neighbors\| − L |
| 24. | m ← DISCONNECTCANDIDATE( ) |
| 25. | if (m ≠ ⊥ [symbol] over > 0) then |
| 26. | send [symbol] DISCONNECT [symbol] to m |
| 27. | else if (m ≠ ⊥ ) |
| 28. | under_covered ← CALCKUNCOVERED |
| | (self_interest,neighbors − { m }) |
| 29. | if (under_covered = 0) then |
| 30. | send [symbol] DISCONNECT [symbol] to m |

Code Section 3: Auxiliary Routines

| | |
|---|---|
| 1. | function int CALCKUNCOVERED(interest,neighbors) |
| 2. | u ← 0 |
| 3. | for each topic ∈ interest do |
| 4. | cover ← { node ∈ neighbors : topic ∈ |
| | node.interest } |
| 5. | if ( \|cover\| < K) then |
| 6. | u ← u + 1 |
| 7. | return u |
| 8. | function node DISCONNECTCANDIDATE( ) |
| 9. | high_degree_neighbors ← { n ∈ neighbors : |
| | n.degree > n.target } |
| 10. | cands ← 0 |
| 11. | uₘᵢₙ ← ∞ |
| 12. | for each n ∈ high_degree_neighbors do |
| 13. | u ← CALCKUNCOVERED(self_interest,{ |
| | neighbors − n }) |
| 14. | if (u < uₘᵢₙ) then |
| 15. | cands ← { n } |
| 16. | uₘᵢₙ ← u |
| 17. | else if (u = uₘᵢₙ) then |
| 18. | cands ← cands ∪ { n } |
| 19. | if (cands ≠ 0) then |
| 20. | return random member of cands |
| 21. | else |
| 22. | return ⊥ |

Code Section 4: Message and Failure Detection Event Handlers

| | |
|---|---|
| 1. | upon receive [symbol] CONNECT,degree,target,interest [symbol] from n |
| | do |
| 2. | if (\|neighbors\| < L^{max} + Margin) then |
| 3. | ADDCONNECTION(n,degree,target, |
| | interest) |
| 4. | if (L < L^{max}) [symbol] (\|neighbors\| < L + Margin) |
| | then |
| 5. | L ← L + 1 |
| 6. | else |
| 7. | cands ← { p ∈ neighbors : p.degree < |
| | p.target + Margin } |
| 8. | m ← argmaxₚ∈_{cands}{\|p.interest ∩ |
| | n.interest\|}, with ties broken randomly |
| 9. | send [symbol] REDIRECT,m [symbol] to n |
| 10. | upon receive [symbol] REDIRECT,m,interest [symbol] from n do |
| 11. | connect_cand_from_redirect ← |
| | connect_cand_from_redirect ∪ { m } |
| 12. | upon receive [symbol] CONNECT-OK, degree, target, |
| | interest [symbol] from n do |
| 13. | if (\|neighbors\| < L^{max} + Margin) then |
| 14. | neighbors ← neighbors ∪ { |
| | n,degree,target,interest } |
| 15. | if (L < L^{max}) [symbol] (\|neighbors\| < L + Margin) |
| | then |
| 16. | L ← L + 1 |
| 17. | else |
| 18. | send [symbol] LEAVE, n [symbol] |
| 19. | upon receive [symbol] LEAVE [symbol] from n do |
| 20. | REMOVECONNECTION(n) |
| 21. | upon receive [symbol] DISCONNECT [symbol] from n do |
| 22. | under_covered ← CALCKUNCOVERED |
| | (self_interest, neighbors − { n }) |
| 23. | if (\|neighbors\| > L [symbol] under_covered = 0) then |
| 28. | REMOVECONNECTION(n) |
| 24. | send [symbol] DISCONNECT-OK [symbol] to n |
| 25. | if under_covered = 0 then |
| 26. | L ← \|neighbors\| |
| 27. | upon receive [symbol] DISCONNECT-OK [symbol] from n do |
| 28. | REMOVECONNECTION(n) |
| 29. | upon FAILUREDETECTIONSUSPECT(node n) do |
| 30. | REMOVECONNECTION(n) |
| 31. | procedure ADDCONNECTION(node n, int degree, int |
| | target, set interest) |
| 32. | neighbors←neighbors∪{ n,degree,target,interest } |
| 33. | send [symbol] CONNECT-OK, \|neighbors\|, L,self_interest [symbol] |
| 34. | procedure REMOVECONNECTION (node n) |
| 35. | remove n from neighbors |
| 36. | under_covered ← CALCKUNCOVERED |
| | (self_interest, neighbors) |
| 37. | if (\|neighbors\| < L) [symbol] (under_covered > 0) then |
| 38. | wake up connectivity task |

Code Section 5: The Greedy and Random Neighbor Selection Routines

| | |
|---|---|
| 1. | function node NEXTGREEDYCOVERAGENODE( ) |
| 2. | cands ← interest_view − neighbors |
| 3. | uncovered ← 0 |
| 4. | for each topic ∈ interest do |
| 5. | cover ← { node ∈ cands : topic ∈ |
| | node.interest } |
| 6. | if (\|cover\| < Kg) then |
| 7. | uncovered ← uncovered ∪ { topic } |
| 8. | node ← argmaxₙ∈_{cands}{ n.interest ∩uncoveredj }, |
| | with ties broken randomly |
| 9. | return node |
| 10. | function node NEXTRANDOMCOVERAGENODE( ) |
| 11. | cands ← interest_view − neighbors |
| 12. | uncovered ← 0 |
| 13. | for each topic∈interest do |
| 14. | cover ← { node ∈ cands : |
| | topic∈node.interest } |
| 15. | if (\|cover\| < Kr) then |
| 16. | uncovered ← uncovered ∪ { topic } |
| 17. | cands ← { n ∈ { interest_view − neighborsᵣ } : |
| | \|n.interest ∩ uncovered\| > 0 } |
| 18. | node ← a random member of cands |
| 19. | return node |

In different embodiments, the invention can be implemented either entirely in the form of hardware or entirely in the form of software, or a combination of both hardware and software elements. For example, a network comprising computing systems N1 through N7, for example, may comprise a controlled computing system environment that can be presented largely in terms of hardware components and software code executed to perform processes that achieve the results contemplated by the system of the present invention.

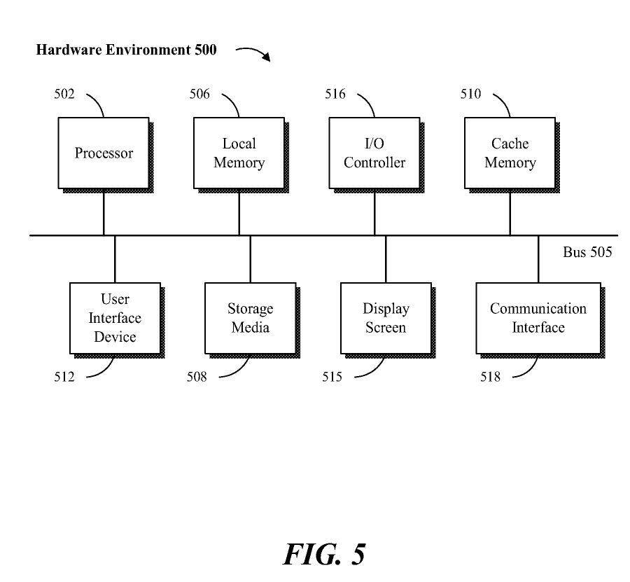

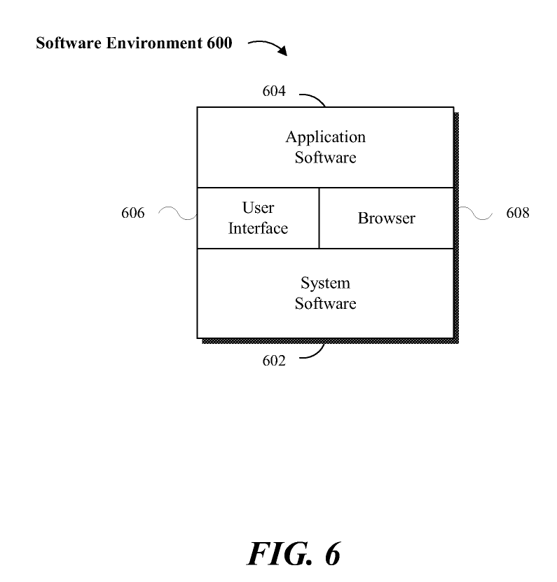

Referring to FIGS. 5 and 6, a computing system environment in accordance with an exemplary embodiment is composed of a hardware environment 500 and a software environment 600. The hardware environment 500 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 600 is divided into two major classes comprising system software 602 and application software 604. System software 602 comprises control programs, such as the operating system (OS) and information management systems that instruct the hardware how to function and process information.

In one embodiment, the algorithms and logic code represented in code sections 1 through 5 or other software implementations including or relating to the greedy and random connecting methods may be implemented as system software 602 and/or application software 604 executed on one or more hardware environments to multicasting in a network. System software 602 and application software 604 may comprise but are not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 5, an embodiment of the system software 602 and application software 604 can be implemented as computer software in the form of computer readable code executed on a data processing system such as hardware environment 500 that comprises a processor 502 coupled to one or more computer readable media or memory elements by way of a system bus 504. The computer readable media or the memory elements, for example, can comprise local memory 506, storage media 508, and cache memory 510. Processor 502 loads executable code from storage media 508 to local memory 506. Cache memory 510 provides temporary storage to reduce the number of times code is loaded from storage media 508 for execution.

A user interface device 512 (e.g., keyboard, pointing device, etc.) and a display screen 515 can be coupled to the computing system either directly or through an intervening I/O controller 516, for example. A communication interface unit 518, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 500 may not include all the above components, or may comprise other components for additional functionality or utility. For example, hardware environment 500 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 518 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 6, system software 602 and application software 604 can comprise one or more computer programs that are executed on top of operating system (not shown) after being loaded from storage media 508 into local memory 506. In a client-server architecture, application software 604 may comprise client software and server software. For example, in one embodiment of the invention, client software is executed on computing systems N1 through N7 and server software is executed on a server system (not shown).

Software environment 600 may also comprise browser software 608 for accessing data available over local or remote computing networks. Further, software environment 600 may comprise a user interface 606 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method of managing multicasting comprising:
determining one or more topics of interest for a first node in a multicasting network;
selecting a second node in the network that shares at least a first topic of interest with the first node;
establishing a connection between the first node and the second node so that the second node covers at least the first topic of interest; and
establishing additional connections between the first node and at least a third node in the network that covers at least the first topic of interest, in response to determining that the first node is not covered by a total of K nodes with respect to the first topic of interest.

2. The method of claim 1 further comprising:
determining whether the first node's coverage with respect to at least the first topic has exceeded a threshold; and
disconnecting the first node from at least the third node.

3. The method of claim 2 wherein the first node is disconnected from at least the third node, in response to determining that the third node remains K times covered with respect to at least one topic of interest to the third node after the connection between the first node and the third node is disconnected.

4. The method of claim 1, wherein the first node has X topics of interest, and wherein the selected second node shares highest number of topics of interest with the first node in comparison to the other nodes in the network, so that when a connection is established between the first node and the second node, the second node covers the highest number of topics of interest for the first node in comparison with remaining unconnected nodes in the network.

5. The method of claim 4, wherein the additional connections with the third node is established such that the third node covers the highest number of topics of interest for the first node in comparison with remaining unconnected nodes in the network.

6. The method of claim 1, wherein the first node has X topics of interest, wherein the selected second node shares at least Y topics of interest with the first node, so that when a connection is established between the first node and the second node, the second node covers at least Y topics of interest for the first node.

7. The method of claim 6, wherein the additional connection with the third node is established such that the third node covers at least Y topics of interest for the first node.

8. The method of claim 7, wherein Y is approximately equal to X.

9. The method of claim 7, wherein Y is equal to X or as close to X as possible.

10. The method of claim 9, further comprising:
determining whether the first node's coverage with respect to a topic of interest has exceeded a threshold; and
disconnecting the first node from the third node, in response to determining that the third node remains K covered with respect to all topics of interest to the third node, after the connection between the first node and the third node is disconnected.

11. A system of managing multicasting, the system comprising:
a logic unit for determining one or more topics of interest for a first node in a multicasting network;
a logic unit for selecting a second node in the network that shares at least a first topic of interest with the first node;
a logic unit for establishing a connection between the first node and the second node so that the second node covers at least the first topic of interest; and
a logic unit for establishing additional connections between the first node and at least a third node in the network that covers at least the first topic of interest, in response to determining that the first node is not covered by a total of K nodes with respect to the first topic of interest.

12. The system of claim 11, further comprising:
a logic unit for determining whether the first node's coverage with respect to at least the first topic has exceeded a threshold; and
a logic unit for disconnecting the first node from at least the third node.

13. The system of claim 12, wherein the first node is disconnected from at least the third node, in response to determining that the third node remains K times covered with respect to at least one topic of interest to the third node after the connection between the first node and the third node is disconnected.

14. The system of claim 11, wherein the first node has X topics of interest, and wherein the selected second node shares highest number of topics of interest with the first node in comparison to the other nodes in the network, so that when a connection is established between the first node and the second node, the second node covers the highest number of topics of interest for the first node in comparison with remaining unconnected nodes in the network.

15. The system of claim 14, wherein the additional connections with the third node is established such that the third node covers the highest number of topics of interest for the first node in comparison with remaining unconnected nodes in the network.

16. A computer program product comprising a computer useable medium having a computer readable program, wherein the computer readable program when executed on a computer causes the computer to:
determine one or more topics of interest for a first node in a network;
select a second node in the network that shares at least a first topic of interest with the first node;
establish a connection between the first node and the second node so that the second node covers at least the first topic of interest; and
establish additional connections between the first node and at least a third node in the network that covers at least the first topic of interest, in response to determining that the first node is not covered by a total of K nodes with respect to the first topic of interest.

17. The computer program product of claim 16, wherein the computer readable program when executed on a computer causes the computer to:
determine whether the first node's coverage with respect to at least the first topic has exceeded a threshold; and
disconnect the first node from at least the third node.

18. The computer program product of claim 17, wherein the computer readable program when executed on a computer causes the computer to disconnect the first node from at least the third node, in response to determining that the third node remains K times covered with respect to at least one topic of interest to the third node after the connection between the first node and the third node is disconnected.

19. The computer program product of claim 16, wherein the computer readable program when executed on a computer causes the computer to establish the first node has X N_{X} topics of interest, and select the second node which shares highest number of topics of interest with the first node in comparison to the other nodes in the network, so that when a connection is established between the first node and the second node, the second node covers the highest number of topics of interest for the first node in comparison with remaining unconnected nodes in the network.

20. The computer program product of claim 19, wherein the computer readable program when executed on a computer causes the computer to establish the additional connections with the third node such that the third node covers the highest number of topics of interest for the first node in comparison with remaining unconnected nodes in the network.
